(19) United States
(12) Patent Application Publication
(10) Pub. No.: US 2012/0030107 A1
(43) Pub. Date: Feb. 2, 2012

(54) Generation And Use Of Transaction Records With Imaging

(75) Inventors: Lisa Gibson, Newman, GA (US); James G. Ronca, Decatur, GA (US); Kerry Cantley, Ft. Mill, SC (US)

(73) Assignee: BANK OF AMERICA CORPORATION, Charlotte, NC (US)

(21) Appl. No.: 12/847,652

(22) Filed: Jul. 30, 2010

(51) Int. Cl. G06Q 40/00

(52) U.S. Cl. 705/43; 705/39

(57) ABSTRACT

Systems and methods for generating transaction records with imaging are described. Data representative of a transaction of a user may be received and a transaction record for the transaction may be generated. A user request to withdraw an amount of monetary funds from an account associated with the transaction may be received. At least one captured image of the user during the transaction may be associated with the transaction record. Monetary funds from the account in the amount requested by the user may be outputted, and the transaction record may be stored in a database. Upon determining the amount of monetary funds requested for withdrawal exceeds a first threshold, at least one image of the user may be captured, and a copy of the at least one captured image of the user or a link to the at least one captured image may be stored in the transaction record.

### BACKGROUND

Security breach monitoring, transaction monitoring, and customer satisfaction are staples in an industry where transactions occur. An entity wants to keep customers as happy with its products and/or services as possible. Entities want to prevent security breaches and monitor it's transactions as closely as possible. Improvements in any and all of these staples are desired goals of an entity.

Transaction data and video information associated with a transaction are not ever linked directly to a transaction. If a problem should arise with a transaction, such as a customer questioning the transaction, a customer filing a claim against an action taken on an account with an entity because of the transaction, or someone accessing an account with an entity because of the transaction, a laborious investigation occurs to attempt to link video data from a video log to the transaction in question. A need exists for an improved system to handle video imaging with transaction data.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the present disclosure are directed to a method and system for generating transaction records with imaging. Data representative of a transaction of a user may be received and a transaction record for the transaction may be generated. A user request to withdraw an amount of monetary funds from an account associated with the transaction may be received. At least one captured image of the user during the transaction may be associated with the transaction record. Monetary funds from the account in the amount requested by the user may be outputted, and the transaction record may be stored in a database. Upon determining the amount of monetary funds requested for withdrawal exceeds a first threshold, at least one image of the user may be captured, and a copy of the at least one captured image of the user, a link to the at least one captured image, or metadata of a marked video file may be stored in the transaction record.

Other aspects of the present disclosure are directed to a method and system for using transaction records with imaging. A request may be received from a customer to access a transaction record associated with a transaction of an individual. A determination may be made as to whether the transaction record includes a copy of at least one image of the individual captured during the transaction. Upon determining the transaction record includes the copy of the at least one image of the individual captured during the transaction, the transaction record may be outputted to a second computing device.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is an illustrative functional block diagram of a self-service financial transaction device (SSFTD) in accordance with at least one aspect of the present disclosure;

FIG. 4 is an illustrative block diagram of a system for storing transaction data in accordance with at least one aspect of the present disclosure;

FIG. 5 is an illustrative flowchart of a method for storing a transaction record in accordance with at least one aspect of the present disclosure;

FIG. 6 is an illustrative flowchart of a method for accessing a transaction record in accordance with at least one aspect of the present disclosure; and

FIGS. 7A-7C are illustrative user interfaces showing illustrative transaction records in accordance with at least one aspect of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

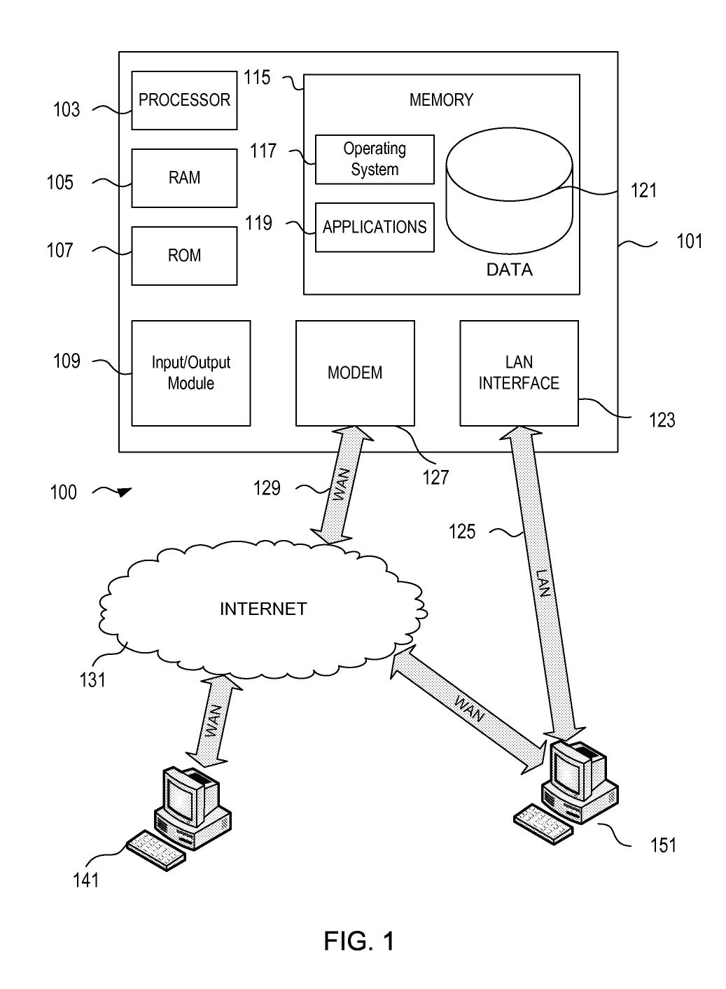

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with individuals, allowing interoperability between different elements of the business residing at different physical locations.

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

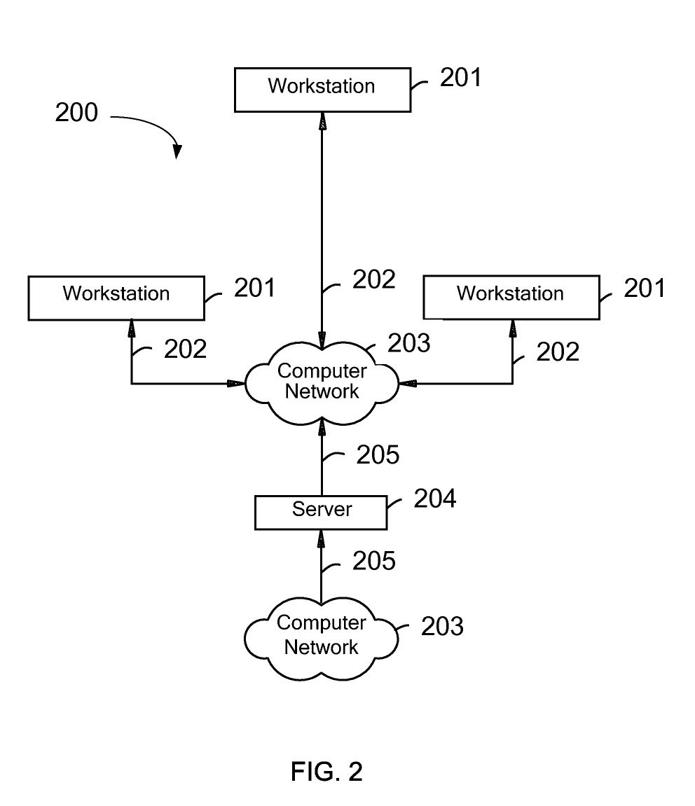

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

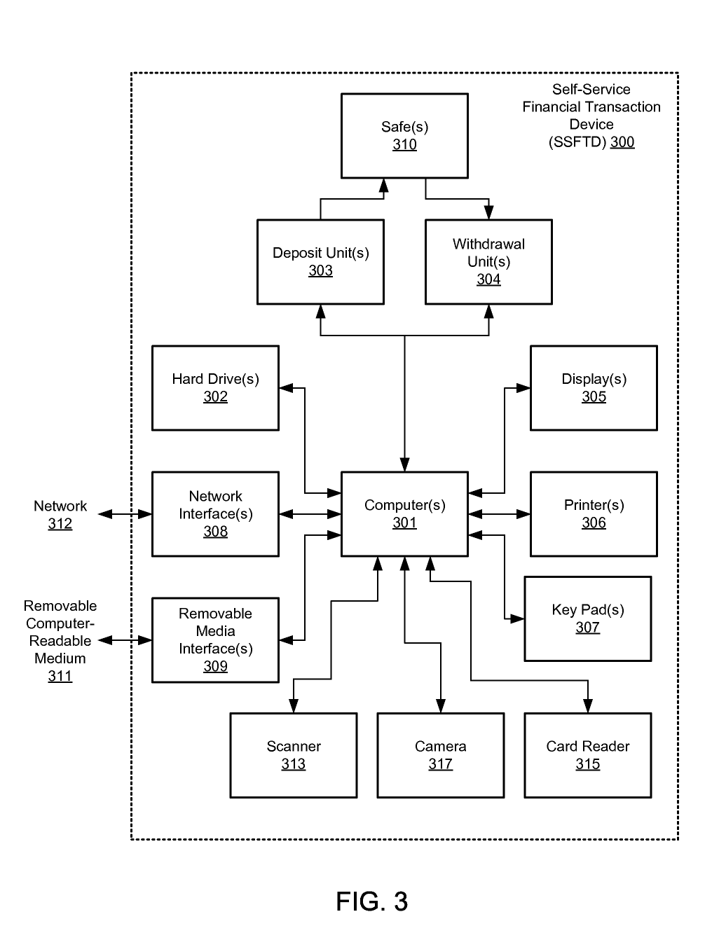

FIG. 3 is an illustrative functional block diagram of a self-service monetary device (SSFTD) 300. SSFTD 300 may include, for instance, an automated teller machine (ATM) or automated kiosk for depositing and/or withdrawing monetary amounts. While the withdrawals are typically provided to the user of the SSFTD 300 as currency, the deposits may be in the form of currency, checks, or other forms.

SSFTD 300 as shown in FIG. 3 includes a computer 301, a hard drive 302 or other computer-readable medium, a deposit unit 303, a withdrawal unit 304, a display 305, a printer 306, a keypad 307, a network interface 308, a removable media interface 309, a safe 310, a scanner 313, a card reader 315, and a camera 317. Although computer 301 is labeled as a “computer,” any one or more of the other functional blocks in FIG. 3 may also be or include a computer. As understood, SSFTD 300 may include one or more computers 301, hard drives 302, deposit units 303, withdrawal units 304, displays 305, printers 306, key pads 307, network interfaces 308, removable media interfaces 309, safes 310, scanners 313, car readers 315, and camera 317.

The term “computer” as referred to herein broadly refers to any electronic, electro-optical, and/or mechanical device, or system of multiple physically separate or physically joined such devices, that is able to process and manipulate information, such as in the form of data. Non-limiting examples of a computer include one or more personal computers (e.g., desktop or laptop), servers, smart phones, personal digital assistants (PDAs), television set top boxes, and/or a system of these in any combination or subcombination. In addition, a given computer may be physically located completely in one location or may be distributed amongst a plurality of locations (i.e., may implement distributive computing). A computer may be or include a general-purpose computer and/or a dedicated computer configured to perform only certain limited functions.

A computer typically includes hardware that may execute software and/or be configured in hardware to perform specific functions. The software may be stored on a computer-readable medium in the form of computer-readable instructions. A computer may read those computer-readable instructions, and in response perform various steps as defined by those computer-readable instructions. Thus, any functions attributed to any of the functional blocks of FIG. 3 as described herein may be implemented, for example, by reading and executing such computer-readable instructions for performing those functions, and/or by any hardware subsystem (e.g., a processor) from which the computer is composed.

The term “computer-readable medium” as used herein includes not only a single physical medium or single type of medium, but also a combination of one or more physical media and/or types of media. Examples of a computer-readable medium include, but are not limited to, one or more memory chips, hard drives (e.g., hard drive 302), optical discs (such as CDs or DVDs), magnetic discs, and magnetic tape drives. A computer-readable medium may be considered part of a larger device or it may be itself removable from the device. For example, a commonly-used removable computer-readable medium is a universal serial bus (USB) memory stick that interfaces with a USB port of a device.

A computer-readable medium may store computer-readable instructions (e.g., software) and/or computer-readable data (i.e., information that may or may not be executable). In the present example, a computer-readable medium (such as memory) may be included in any one or more of the functional blocks shown in FIG. 3 and may store computer-executable instructions and/or data used by any of those functional blocks. Alternatively or additionally, such a computer-readable medium storing the data and/or software may be physically separate from, yet accessible by, any of the functional blocks shown in FIG. 3.

Where SSFTD 300 is an ATM, computer 301 is typically embodied as a personal computer. In this example, computer 301 may be responsible for the overall control of SSFTD 100. To perform such control, computer 301 may execute, for example, one or more software applications, one or more device control programs, and one or more operating systems, each of which may be stored on hard drive 302, which may be a single physical hard drive or multiple physical hard drives. These various elements will be discussed in further detail below.

Hard drive 302 may be a single physical hard drive unit or may include multiple physical hard drive units. Rather than, or in addition to, hard drive 302, SSFTD 300 may store data and/or computer-executable instructions on one or more other types of computer-readable medium, such as an optical disc drive, a magnetic tape drive, and/or memory chips.

Deposit unit 303 may be responsible for physically receiving deposited items such as currency and checks, for physically counting the deposited items, for physically holding the deposited items in an escrow area during a deposit transaction, for determining the value of the deposited items, and for physically transferring the deposited items to safe 310 when the transaction is complete.

Withdrawal unit 304 may be responsible for physically retrieving currency or other items from safe 310 during a withdrawal transaction, and for physically providing the retrieved currency to the user.

Display 305 may be responsible for displaying a visual user interface to the user, and may also incorporate a touch screen capability for receiving user input. Typical information that may be presented on display 305 includes text and/or graphics representing the status of a transaction. Likewise, printer 306 may be responsible for presenting a paper printout containing information about a transaction.

Key pad 307 may include one or more buttons, switches, and/or other physical user input elements, and may be responsible for receiving user input associated with a transaction. For example, key pad 307 may include digit keys zero through nine and other function keys. Card reader 315 may be any type of device that reads data from a card, such as the magnetic strip on magnetic cards such as ATM/bank cards.

Network interface 308 may be responsible for data communication between SSFTD 300 and a network 312. The communication may be uni-directional or bi-directional. Network 312 may be a single network or combination of multiple coupled networks, and may be wireless and/or wired. Examples of network 312, or portions thereof, include the Internet, a cellular telephone network, a cellular data network, a wired or wireless local area network, and a satellite communication network.

Removable media interface 309 may be responsible for reading from and/or writing to a removable computer-readable medium 311, such as a USB key, a compact disc (CD), a floppy magnetic disc, or a portable hard drive. Removable media interface 309 may therefore include a physical port for plugging in or otherwise temporarily receiving removable computer-readable medium 311. This port may be physically part of, for instance, the housing of computer 301. However, the port may be located elsewhere in or on SSFTD 300, such as on a rear housing of SSFTD 300 that may be accessible to maintenance servicers of SSFTD 300 but not necessarily to the general public. Regardless of the location of the port, data read from removable computer-readable medium 311 by removable media interface 309 may be provided to computer 301, and data provided by computer 301 may be written by removable media interface 309 to computer-readable medium 311.

Scanner 313 may include, for instance, a camera that is able to take a digital photograph of a check to produce one or more images representing the front and/or back of the check. In addition to generating an image of the check, scanner 313 may be further capable of reading magnetically printed information on the check, such as magnetic ink that is typically printed on a check, and performing magnetic ink character recognition (MICR). Such MICR processes are well known. The data produced by performing MICR that represents the recognized magnetic ink characters is referred to herein as MICR data. Scanner 313 further may be configured to capture an access code as described herein.

Camera 317 may be able to take digital photographs to produce one or more images of an individual making a transaction with the SSFTD 300. Camera 317 may be capable of capturing images of the individual as separate images and/or as a video of images. Camera 317 may be configured to being recording at the occurrence of initiating of use of the SSFTD 300 by an individual, such as by the scanning of an access card at card reader 315. Camera 317 then may stop recording at the end of the transaction, such as by the individual taking her access card and leaving the field of view of the camera 317. In anther example, camera 317 may be configured to record at all times. As described in more detail below, upon initiation of a transaction with the SSFTD 300, camera 300 may be configured to mark the video file at the SSFTD 300 with metadata regarding the transaction of the individual. For example, the video file may be marked with metadata of a transaction number assigned by the entity operating the SSFTD 300 to the transaction of the individual.

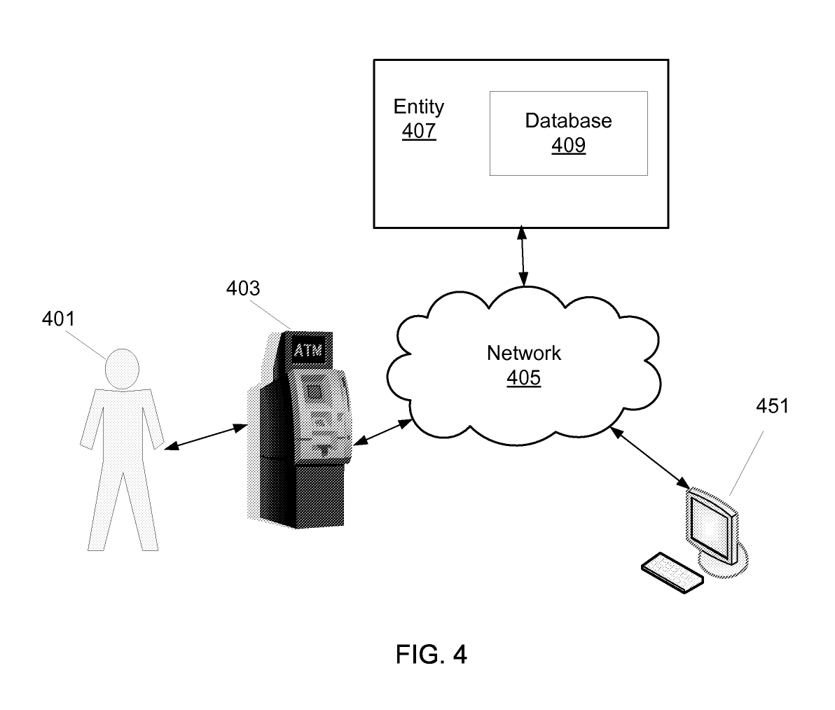

FIG. 4 is an illustrative block diagram of a system for storing transaction data in accordance with at least one aspect of the present disclosure. The system shows a user 401 accessing a self service financial transaction device 403, such as an automated teller machine (ATM). Self service financial transaction device 403 may be a self service financial transaction device 300 as described in FIG. 3. Self service financial transaction device 403 is shown operatively connected to network 405. Network 405 may include one or more wired networks, wireless networks, and/or combinations of wired and wireless networks. Network 405 may be network 312 as described in FIG. 3, Internet 101 as described in FIG. 1, and/or computer network 203 as described in FIG. 2.

An entity 407 may be operatively connected to network 405. Entity 407 may operate the self service financial transaction device 403. Entity 407 may be a financial entity offering financial services and products through the self service financial transaction device 403 to its customers. Entity 407 is shown to include a database 409. Although shown within entity 407, database 409 may be one or more memories maintained at one or more different physical locations. In addition, database 409 may be a memory located at a physical location separate from entity 407 but may be under the control of entity 407 and/or may be licensed for operation by entity 407.

Computer 451 is shown operatively connected to network 405. Computer 451 may be a computer 101, 141, and/or 151 as described in FIG. 1 and/or a workstation 201 as described in FIG. 2. Computer 451 may be operatively connected to network 405 by any of a number of different manners including a wireless connection, a wired connection, or a combination of wired and wireless connections.

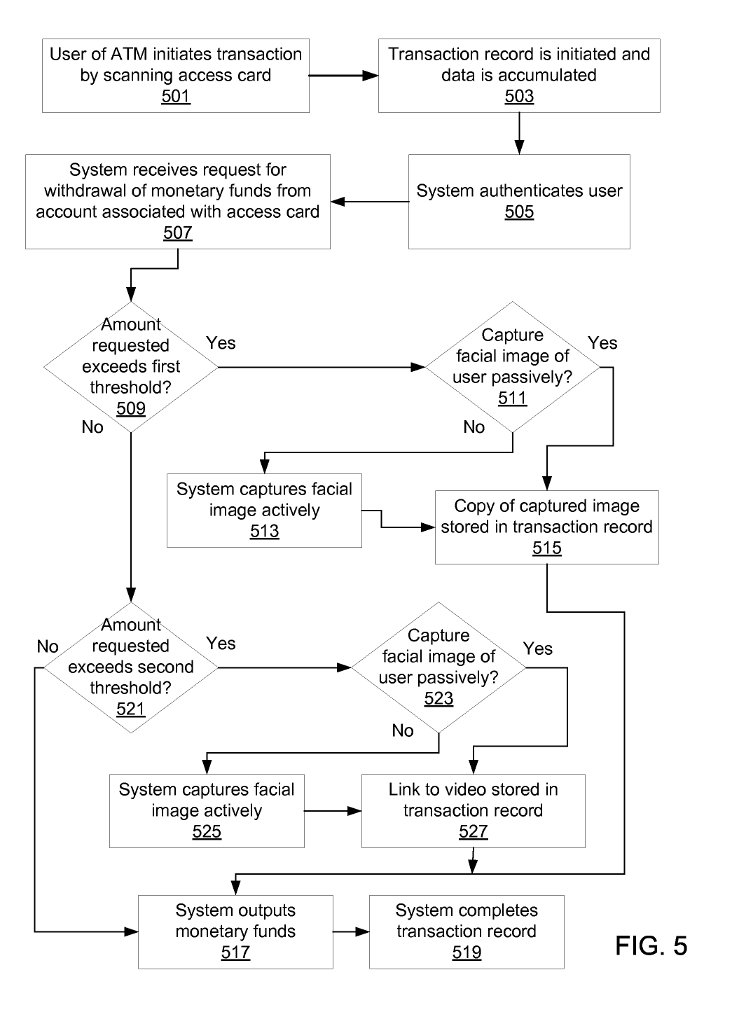

FIG. 5 is an illustrative flowchart of a method for storing a transaction record in accordance with at least one aspect of the present disclosure. The process starts and at 501 a user of a financial transaction device initiates a transaction with the financial transaction device by scanning an access card. Such a user may be user 401 scanning an access card at self service financial transaction device 403 in FIG. 4. The self service financial transaction device may be an ATM. The user in 501 may scan the access card by way of a card reader, such as card reader 315 in FIG. 3. The scanned access card may be distributed by and/or associated with an entity of the self service financial transaction device, such as entity 407 in FIG. 4.

Proceeding to 503, a transaction record for the transaction is initiated and data of the transaction is accumulated. The accumulated data may be any data associated with the transaction. Such data may include a transaction number, an account number associated with the scanned access card, and a customer name associated with the scanned access card and/or account number. Additional accumulated data may include a date of the transaction, a time of the start of the transaction, and a time of the end of the transaction. Still additional accumulated data may include a type of the transaction. For example, the type may be a deposit of monetary funds, whether checks and/or cash, a withdrawal of monetary funds, an inquiry into an account associated with the scanned access card, and/or other type of transactions. Other accumulated data includes the monetary amount associated with the transaction, an access method, such as by scanned access card or by credit card, and whether a customer associated with the scanned access card is a customer of an entity associated with the self service financial transaction device. Still other data may be accumulated and stored with respect to the transaction.

In 505, the system authenticates the user. Any of a number of manners may be utilized to authenticate the user and the present disclosure is not limited to any particular authentication. An example manner for authentication includes requesting and receiving a personal identification number (PIN) associated with the scanned access card. Still other example manners for authentication include scanning a biometric parameter of the user of the scanned access card, such as an iris and/or a fingerprint. These and other example manners for authentication of a user of the scanned access card may be utilized in accordance with the present disclosure.

Proceeding to 507, the system receives a request for withdrawal of monetary funds from an account associated with the scanned access card. Such a request may be a user input received via key pad 307 as described in FIG. 3 for withdrawal of cash from a checking account. In 509, a determination may be made as to whether the amount requested for withdrawal of monetary funds exceeds a first threshold. Such a first threshold may be a predetermined amount set by the entity operating the self service financial transaction device. If the first threshold is exceeded in 509, the process moves to 511. If the first threshold amount is not exceeded in 509, the process moves to 521.

In 511, a determination is made as to whether a facial image of the user may be and/or may have been captured passively. Passive capture of a facial image of a user is the capture of a facial image of a user without the prompting of the user to perform a specific action to capture the facial image, i.e., active capture. For example, during the process of scanning the access card in 501, entering a PIN number associated with the access card as part of authentication in 505, or entering the request via a key pad in 507, a camera of the self service financial transaction device, such as camera 317 described in FIG. 3 may have captured one or more facial images of the user. If a facial image of the user is or may be captured passively, the process proceeds to 515, else the process moves to 513.

In 513, the system captures a facial image of the user actively. The system may output a prompt to the user to stand in a certain position or place her head within a field of view of a camera associated with the self service financial transaction device. As such, the system may capture at least one facial image of the user actively. In 515, a copy of the captured image is stored in the transaction record. With at least one image stored with the transaction record, future access to the transaction record will pull the at least one image for viewing as well.

The process proceeds to 517 where the system outputs monetary funds to the user in accordance with the requested amount. The system may output the monetary funds by a withdrawal unit 304 as described in FIG. 3. Then, in 519, the system completes the transaction record for inclusion of any additional information. The completed transaction record may be stored within a memory of the self service financial transaction device and/or in one or more memories external to the self service financial transaction device. An example external memory includes database 409 described in FIG. 4.

In 521, a determination may be made as to whether the amount requested for withdrawal of monetary funds exceeds a second threshold. Such a second threshold may be a predetermined amount set by the entity operating the self service financial transaction device. If the second threshold is exceeded in 521, the process moves to 523. If the second threshold amount is not exceeded in 521, the process moves to 517. In 523, a determination is made as to whether a facial image of the user may be and/or may have been captured passively. If a facial image of the user is or may be captured passively, the process proceeds to 527, else the process moves to 525.

In 525, the system captures a facial image of the user actively. In 527, a link to the video with the captured image is stored in the transaction record. With the link stored with the transaction record, future access to the transaction record may include a link to the video file that includes the captured image for viewing as well. As understood, although the description of FIG. 5 is with respect to the capturing and use of images, groups of images, i.e., video, may be utilized in a similar capacity. For example, in 515 a copy of captured video may be stored within a transaction record. Similarly, in 527, a link to the video with the captured images may be stored in a transaction record.

Capturing an image and storing with a financial record may include a higher cost than just text data of a financial record. As such, the different thresholds may correspond to monetary amounts that warrant an increased amount of security and authentication for the transaction. For example, a transaction record with a copy of a captured image included would survive a situation where the original video file was lost, overwritten, changed, and/or damaged. However, a transaction record with only a link to the portion of the video file with the captured image may not operate if the video file was lost, overwritten, changed, and/or damaged.

One example use may be to set the first threshold at any amount that is $10,000 or more and a second threshold at any amount greater that $500 and less than $10,000. As such, if a user attempts to withdrawal $12,000 from an account, a copy of a captured image and/or video of the user at the transaction is stored in a transaction record of the transaction. If the transaction is questioned later, due to exceeding the first threshold of $10,000, the transaction record maintains the captured image or video for immediate identification of the user. If the original video file has been overwritten, the transaction record still stores the captured image and/or video. However, if the user attempts to withdrawal $1000 from an account, only a link to that portion of the video file when the transaction occurred may be stored in a transaction record of the transaction. This maintenance of a link in place of a copy of an image or video may be less expensive to implement and therefore, because the amount in question is lower than the $10,000 threshold, a less expensive form of security and authentication is desired.

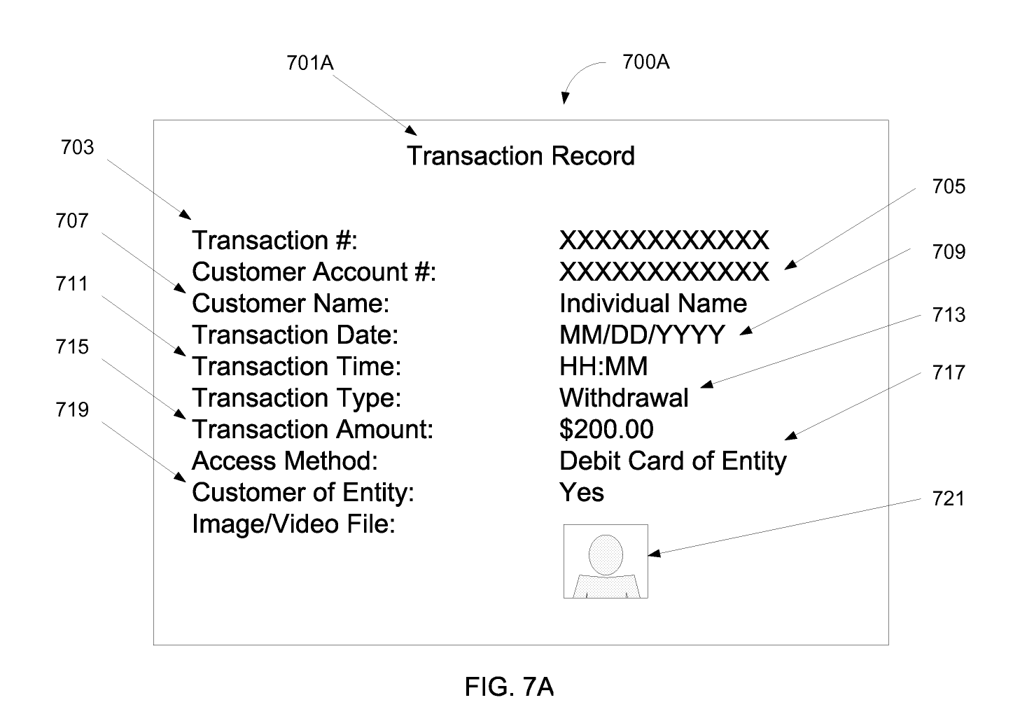

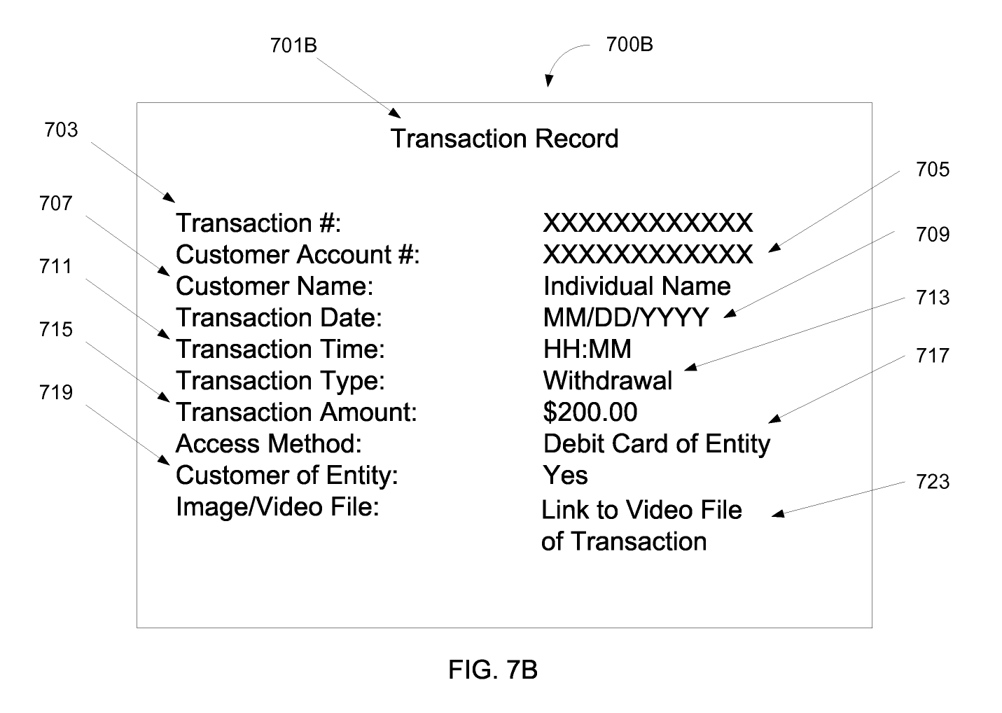

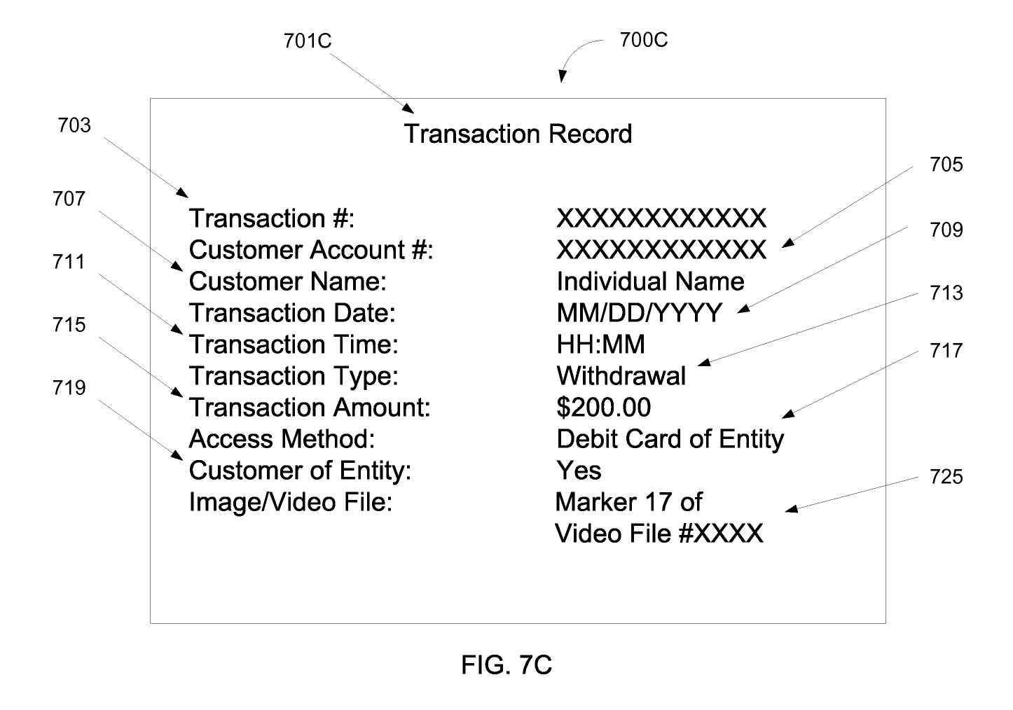

Aspects of the present disclosure describe a system for modifying and/or utilizing data from a video and/or image for use with a transaction record. In accordance with aspects described herein, there are three manners to utilize video for a transaction record. In a first example, a portion of video may be captured and included within a transaction record. Such an example is described above with respect to 515 in FIG. 5 and is shown in FIG. 7A and described more fully below. In a second example, a link to a particular part of the video file may be created in a transaction record. Such an example is described above with respect to 527 in FIG. 5 and is shown in FIG. 7B and described more fully below.

In a third example, an actual video file may be marked with pointer data. This marker of metadata may be maintained within the video file. For example, when a transaction is initiated, the video file at the self service financial transaction device may have a metadata created to mark the beginning of the transaction. Any of a number of data may be utilized to mark the video file, including metadata of a transaction identification number. As such, a transaction record associated with the transaction may include data corresponding to the metadata marked in the video file. Therefore, if needed, the metadata in the transaction record may be utilized to find the associated video and/or captured image form the video file at a later time. Such an example is shown in FIG. 7C and described more fully below.

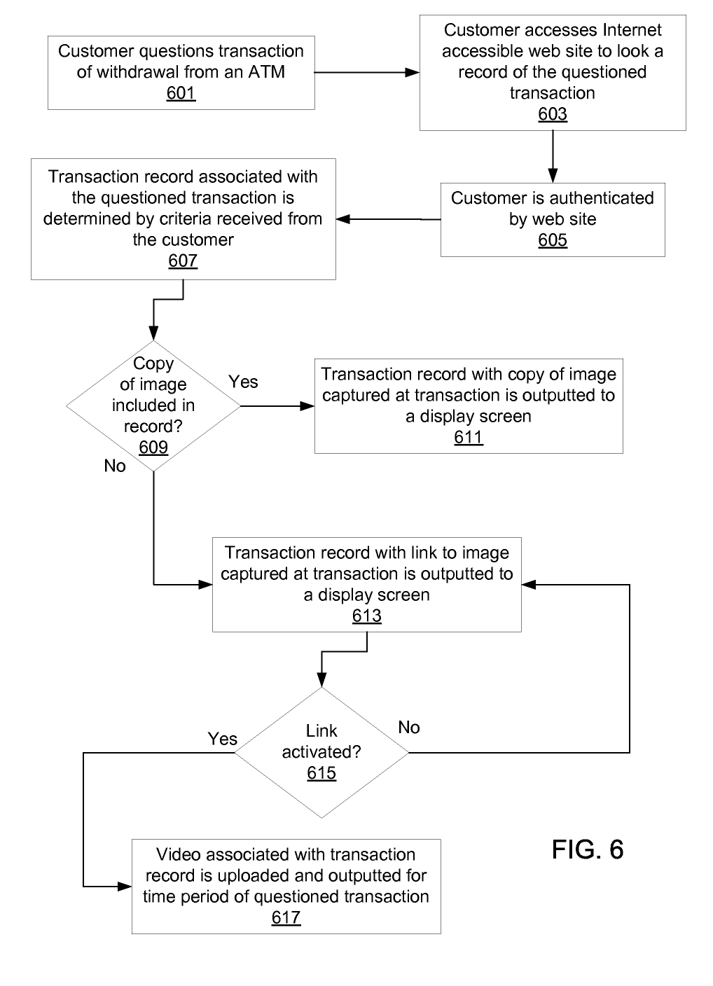

FIG. 6 is an illustrative flowchart of a method for accessing a transaction record in accordance with at least one aspect of the present disclosure. The example of FIG. 6 may be a situation where a customer questions the legitimacy of a transaction. The process starts and at 601, a customer questions a transaction relating to a withdrawal of monetary funds from a self service financial transaction device, such as an ATM. A customer may review her financial entity statement, whether in paper form or via a web page, showing all transactions. Upon review, the customer may believe that a particular transaction is not legitimate, e.g., that someone withdrew monetary funds from her account without authorization to do so.

In 603, the customer may access an Internet accessible web site to review a transaction record of the questioned transaction. An entity associated with the financial service may have a web site that customers may use to first investigate a transaction before contacting a representative for the financial entity and/or filing a claim against the transaction. Such can save time and money as many transactions initially thought to be illegitimate later, after an exhaustive investigation, are found to be legitimate. However, although FIG. 6 is described with respect to the perspective of a customer, other individuals may utilize aspects of the present disclosure, including customer service representative of the entity.

Proceeding to 605, the customer is authenticated by the web site. Any of a number of manners of authentication of the customer may be utilized. For example, a customer may be prompted to provide a user identification number or code and a password. Upon being authenticated into the web site, the process moves to 607. In 607, a transaction record associated with the questioned transaction is determined. This determination may be made based upon one or more criteria received from the customer. For example, from review of the statement of financial services, the customer may input data of the time of the transaction, the location of the transaction, the date of the transaction, the amount of the transaction, and/or any of a number of other transaction record identification data. Upon determining the transaction record associated with the questioned transaction, the process moves to 609.

In 609, a determination is made as to whether a copy of a captured image or video is included within the transaction record associated with the questioned transaction. If a copy of a captured image or video from the transaction is included in the transaction record, the process moves to 611 where the transaction record with the copy of the image and/or video captured at the transaction in question is outputted to a display screen. Such a display screen may be a display screen associated with computer 451 in FIG. 4. With the transaction record including a copy of the captured image or video from the actual transaction in question, the customer may see a picture of the individual taking part in the transaction. If the image shows the customer, it may be reminder that the customer forgot the transaction occurred. Or the captured image may be of the spouse of the customer and she may therefore know that the spouse was responsible for the transaction and that the transaction was therefore legitimate.

FIG. 7A is an illustrative user interface 700A showing an illustrative transaction record 701A for such a situation as in 611 in accordance with at least one aspect of the present disclosure. Transaction record 701A includes any of a number of different transaction data associated with the transaction. Such transaction data may include a transaction number 703, a customer account number 705, a customer name associated with the account 707, a transaction date 709 and/or a transaction time 711. In addition, the transaction data may include data of the type of transaction 713, such as withdrawal, deposit, inquiry, etc., data of the type of account (not shown), such as checking, savings, money market, etc., an amount of the transaction 715, data of the method of access 717, such as via credit card, debit card or third party entity, debit card of entity associated with the self service financial transaction device used for the transaction, etc., and data indicating whether the customer for the transaction is a customer of the entity 719. Such data may be useful in knowing whether the customer questioning the transaction is a one time customer or long standing customer of the entity.

As shown in FIG. 7A, transaction record 700A includes data of a copy of an image and/or video 721 captured during the questioned transaction. A quick review of the image may indicate to a customer that she forgot about the transaction and/or that the individual shown in the image is definitely someone she knows, such as a spouse or child. As such, the customer initially questioning the transaction need not contact a customer service representative of the financial entity to inquire as to the transaction but can initially investigate the transaction herself. If the copy of the image and/or video is not someone the customer knows, she may then contact the financial entity to indicate such, thus initiating an investigation as to the perpetrator of the transaction.

If it is determined in 609 that a copy of a captured image or video from the transaction is not included in the transaction record, the process moves to 613 where the transaction record with a link to an image and/or video captured at the transaction in question is outputted to a display screen. Such a display screen may be a display screen associated with computer 451 in FIG. 4.

FIG. 7B is an illustrative user interface 700B showing an illustrative transaction record 701B for such a situation as in 613 in accordance with at least one aspect of the present disclosure. Transaction record 701B includes any of a number of different transaction data associated with the transaction. Such transaction data may include one or more of the same data as illustratively shown in FIG. 7A. As shown in FIG. 7B, transaction record 700B includes a link to a captured image and/or video file 723 recorded during the questioned transaction. The link 723 may be an Internet accessible web site that is accessible by the customer and/or customer service representative upon initiating a launch of the link, e.g., clicking a mouse input on the link. In the case of a customer service representative, the link may be to a server and/or other physical device that is maintained in a private network, not accessible via the Internet. Any of a number of safeguards, firewalls, and/or security and authentication systems may be implemented to maintain the integrity of the video file and transaction records and/or to limit access to the video file and transaction records.

Returning to FIG. 6, in 615, a determination may be made as to whether the link to the video file has been activated. As previously stated, such an activation may be inputting a mouse input to the link by a customer at 723 in FIG. 7B. If the link has not been activated, the process may return to 613. If the link has been activated in 615, the process may proceed to 617 where the video file associated with the link in the transaction record is uploaded and outputted to a display screen of the customer. Such a display screen may include a display screen associated with computer 451 in FIG. 4. The outputted video file may include captured frames, e.g., images, form the video file of the user during the transaction in question and/or may be the time period for the entire video from start to completion of the questioned transaction. As such, a customer can review the captured images form the video file directly and/or the entire time period of the video file to see if she can determine whether the transaction in question is a legitimate transaction.

Although not shown in FIG. 6, a process may include the transaction record with a marker position to an image and/or video captured at the transaction in question is outputted to a display screen. Such a display screen may be a display screen associated with computer 451 in FIG. 4. FIG. 7C is an illustrative user interface 700C showing an illustrative transaction record 701C for such a situation in accordance with at least one aspect of the present disclosure. Transaction record 701C includes any of a number of different transaction data associated with the transaction. Such transaction data may include one or more of the same data as illustratively shown in FIGS. 7A and 7B. As shown in FIG. 7C, transaction record 700C includes a marker position to a captured image and/or video file 725 recorded during the questioned transaction. The marker position 725 may metadata inserted into the video file at the time of recording. The metadata may include some form of identification to associate with the transaction record, such as a video file number and a transaction identification number. The marker may be accessible by the customer and/or customer service representative upon initiating a launch of the video file, e.g., clicking a mouse input on the link. In the case of a customer service representative, the representative may access the video file and search for the marker number by way of the metadata 725. In the example of FIG. 7C, the representative may look to marker 17 in the video file #XXXX to see the video portion of the questioned transaction.

While illustrative systems and methods as described herein embodying various aspects of the present disclosure are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present disclosure. The description is thus to be regarded as illustrative instead of restrictive on the present invention.

What is claimed is:

1. A method comprising:
receiving, at a computing device, data representative of a transaction of a user;
generating, at the computing device, a transaction record for the transaction, the transaction record including user identifiable data for the transaction;
receiving, at the computing device, a user request to withdraw an amount of monetary funds from an account associated with the transaction;
associating, at the computing device, at least one captured image of the user during the transaction with the transaction record;
outputting, at the computing device, monetary funds from the account in the amount requested by the user; and
storing, at the computing device, the transaction record in a database.

2. The method of claim 1, further comprising authenticating, at the computing device, the user to the account associated with the transaction.

3. The method of claim 1, further comprising:
determining whether the amount of monetary funds requested to be withdrawn from the account associated with the transaction exceeds a first threshold; and
upon determining the amount of monetary funds exceeds the first threshold, capturing, at the computing device, at least one image of the user,
wherein the associating includes storing a copy of the at least one captured image of the user in the transaction record.

4. The method of claim 3, wherein the capturing includes capturing at least one image of the user passively.

5. The method of claim 3, wherein the capturing includes capturing at least one image of the user actively.

6. The method of claim 3, further comprising:
upon determining the amount of monetary funds requested to be withdrawn from the account associated with the transaction does not exceed a first threshold, determining whether the amount of monetary funds requested to be withdrawn from the account associated with the transaction exceeds a second threshold; and
upon determining the amount of monetary funds exceeds the second threshold, capturing, at the computing device, at least one image of the user,
wherein the associating includes storing a link to the at least one captured image of the user in the transaction record.

7. The method of claim 1, further comprising:
determining whether the amount of monetary funds requested to be withdrawn from the account associated with the transaction exceeds a first threshold; and
upon determining the amount of monetary funds exceeds the first threshold, capturing, at the computing device, at least one image of the user,
wherein the associating includes storing a link to the at least one captured image of the user in the transaction record.

8. The method of claim 1, further comprising:
determining whether the amount of monetary funds requested to be withdrawn from the account associated with the transaction exceeds a first threshold; and
upon determining the amount of monetary funds exceeds the first threshold, capturing, at the computing device, at least one image of the user,
wherein the associating includes storing metadata of a location within a video file to the at least one captured image of the user in the transaction record.

9. The method of claim 1, wherein the at least one captured image is a video.

10. The method of claim 1, wherein the data representative of the transaction of the user includes data representative of a scanned access card associated with an entity operating a self service financial transaction device.

11. One or more computer-readable media storing computer-readable instructions that, when executed by at least one computer, cause the at least one computer to perform a method of:
receiving data representative of a transaction of a user;
generating a transaction record for the transaction, the transaction record including user identifiable data for the transaction;
receiving a user request to withdraw an amount of monetary funds from an account associated with the transaction;
associating at least one captured image of the user during the transaction with the transaction record;
outputting monetary funds from the account in the amount requested by the user; and
storing the transaction record in a database.

12. The one or more computer readable media of claim 11, the instructions further causing the at least one computer to perform a method of:
determining whether the amount of monetary funds requested to be withdrawn from the account associated with the transaction exceeds a first threshold; and
upon determining the amount of monetary funds exceeds the first threshold, capturing at least one image of the user,
wherein the associating includes storing a copy of the at least one captured image of the user in the transaction record.

13. The one or more computer readable media of claim 12, the instructions further causing the at least one computer to perform a method of:
upon determining the amount of monetary funds requested to be withdrawn from the account associated with the transaction does not exceed a first threshold, determining whether the amount of monetary funds requested to be withdrawn from the account associated with the transaction exceeds a second threshold; and
upon determining the amount of monetary funds exceeds the second threshold, capturing at least one image of the user,
wherein the associating includes storing a link to the at least one captured image of the user in the transaction record.

14. The one or more computer readable media of claim 11, the instructions further causing the at least one computer to perform a method of:
determining whether the amount of monetary funds requested to be withdrawn from the account associated with the transaction exceeds a first threshold; and
upon determining the amount of monetary funds exceeds the first threshold, capturing at least one image of the user,
wherein the associating includes storing metadata of a location within a video file to the at least one captured image of the user in the transaction record.

15. The one or more computer readable media of claim 11, wherein the at least one captured image is a video.

16. An apparatus comprising:
at least one processor; and
at least one memory having stored therein computer executable instructions, that when executed by the at least one processor, cause the apparatus to perform a method of:
receiving data representative of a transaction of an individual;
generating a transaction record for the transaction, the transaction record including individual identifiable data for the transaction;
receiving an individual request to withdraw an amount of monetary funds from an account associated with the transaction;
associating at least one captured image of the individual during the transaction with the transaction record;
outputting monetary funds from the account in the amount requested by the individual; and
storing the transaction record in the at least one memory.

17. The apparatus of claim 16, further comprising at least one camera configured to capture, from the individual, at least one image of the individual during the transaction.

18. The apparatus of claim 16, further comprising at least one withdrawal unit configured to output the monetary funds in the amount requested by the individual.

19. The apparatus of claim 16, the instructions further causing the at least one processor to perform a method of:
determining whether the amount of monetary funds requested to be withdrawn from the account associated with the transaction exceeds a first threshold; and
upon determining the amount of monetary funds exceeds the first threshold, capturing at least one image of the individual,
wherein the associating includes storing a copy of the at least one captured image of the individual in the transaction record.

20. The apparatus of claim 19, the instructions further causing the at least one processor to perform a method of:
upon determining the amount of monetary funds requested to be withdrawn from the account associated with the transaction does not exceed a first threshold, determining whether the amount of monetary funds requested to be withdrawn from the account associated with the transaction exceeds a second threshold; and
upon determining the amount of monetary funds exceeds the second threshold, capturing at least one image of the individual,
wherein the associating includes storing a link to the at least one captured image of the individual in the transaction record.

21. The apparatus of claim 16, the instructions further causing the at least one processor to perform a method of:
determining whether the amount of monetary funds requested to be withdrawn from the account associated with the transaction exceeds a first threshold; and
upon determining the amount of monetary funds exceeds the first threshold, capturing at least one image of the individual,
wherein the associating includes storing metadata of a location within a video file to the at least one captured image of the individual in the transaction record.

22. A method comprising:
receiving a request from a customer to access a transaction record associated with a transaction of an individual;
determining whether the transaction record includes a copy of at least one image of the individual captured during the transaction; and
upon determining the transaction record includes the copy of the at least one image of the individual captured during the transaction, outputting the transaction record to a second computing device.

23. The method of claim 22, further comprising authenticating the customer to access the transaction record.

24. The method of claim 22, further comprising:
receiving from the customer at least one criterion associated with the transaction; and
determining the transaction record associated with the transaction based upon the at least one criterion.

25. The method of claim 22, further comprising upon determining the transaction record does not include the copy of the at least one image of the individual captured during the transaction, outputting the transaction record to the second computing device, the transaction record including a link to at least one image of the individual captured during the transaction.

26. The method of claim 25, further comprising:
receiving a request from the customer to access the link to the at least one image of the individual captured during the transaction;
uploading the at least one image of the individual captured during the transaction; and
outputting the at least one image to the second computing device.
